(19) United States
(12) Patent Application Publication
(10) Pub. No.: US 2012/0023432 A1
(43) Pub. Date: Jan. 26, 2012

(54) ICONS WITH SUBPARTS PRESENTING INFORMATION ABOUT A SYSTEM

(75) Inventor: Jerry G Aguren, Tomball, TX (US)

(73) Assignee: Hewlett-Packard Development Company, L.P., Houston, TX (US)

(21) Appl. No.: 13/260,127

(22) PCT Filed: Oct. 6, 2009
(86) PCT No.: PCT/US09/59712

§ 371 Date: Sep. 23, 2011

(51) Int. Cl. G06F 3/048

(52) U.S. Cl. 715/772

(57) ABSTRACT

One embodiment is a method that generates a map of a system. The map includes an icon that is divided into multiple parts that depict different operational information about a device in the system.

### FIELD OF THE INVENTION

The present invention relates to using icons with subparts to present state information about a system.

### BACKGROUND

Data centers and other networking infrastructures have enormous numbers of cable and wires connecting various electronic devices. Even though such facilities are highly organized, the number of cables and electronic devices can be overwhelming. The task of monitoring and maintaining these cables and devices is complex.

In order to effectively manage a data center or other facility with large amounts of electronic equipment, sufficient information about cables, connections, and electronic devices is required.

### BRIEF DESCRIPTION OF THE DRAWINGS

FIG. 1 shows a dynamic icon with a plurality of different zones or parts in accordance with an example embodiment.

FIG. 2 shows an icon system in accordance with an example embodiment.

FIG. 3 shows an icon system with an electronic device being displayed in accordance with an example embodiment.

FIG. 4 shows multiple dynamic icons used together to provide operational information of a one-sided cable subsystem in accordance with an example embodiment.

FIG. 5 shows a topology map of a data center using dynamic icons to display local and systemic information in accordance with an example embodiment.

FIG. 6 shows a flow diagram for generating and displaying dynamic icons to provide state information about a storage system in accordance with an example embodiment.

FIG. 7 shows a computer executing methods in accordance with an example embodiment.

### SUMMARY OF THE INVENTION

Example embodiments relate to systems, methods, and apparatus that use dynamic icons with subzones to present diagnostic information for systems.

### DETAILED DESCRIPTION

Example embodiments relate to systems, methods, and apparatus that use dynamic icons with subparts or subzones to present diagnostic information for systems. In one embodiment, the icons are divided into a plurality of different parts or zones.

One embodiment displays a topology map of a data center and underlying node data for all devices in the data center. The topology map describes the connection between devices, such as servers, switches, and storage devices. Icons with multiple subparts or subzones are displayed on the map to provide information (such as operational states) of electronic devices in the data center.

One embodiment visually displays dynamic icons that represent abstract or concrete components in a storage system. For example, diagnosing problems of complex storage systems (such as data centers) can be solved using a decision tree, sometimes called a diagnostic tree or fault tree. Example embodiments use a diagnostic tree or groups of diagnostic trees along with dynamic icons to provide real-time operational state information of components in the storage system.

As used herein and in the claims, a “dynamic icon” is an icon that visually changes appearance to present different states or information about any aggregate of components or software. Furthermore, an icon can represent a single device or multiple devices, firmware, or an operating system. Dynamic icons can be updated and changed in real-time to display current information about devices in systems as the state information about the devices changes (e.g., devices in a storage system, such as cables, servers, switches, routers, host bus adapters, etc.). These icons can include multiple zones (e.g., multiple different areas) or multiple parts (e.g., multiple different symbols). Example embodiments are not limited to any particular number of zones or parts in an icon.

For illustration, some example embodiments are discussed herein with regard to a storage system. Example embodiments, however, are applicable to a wide range of systems including, but not limited to, storage systems, computer systems, and other electronic systems, such as complex time varying systems (air traffic control, petroleum plants, assembly lines, etc.).

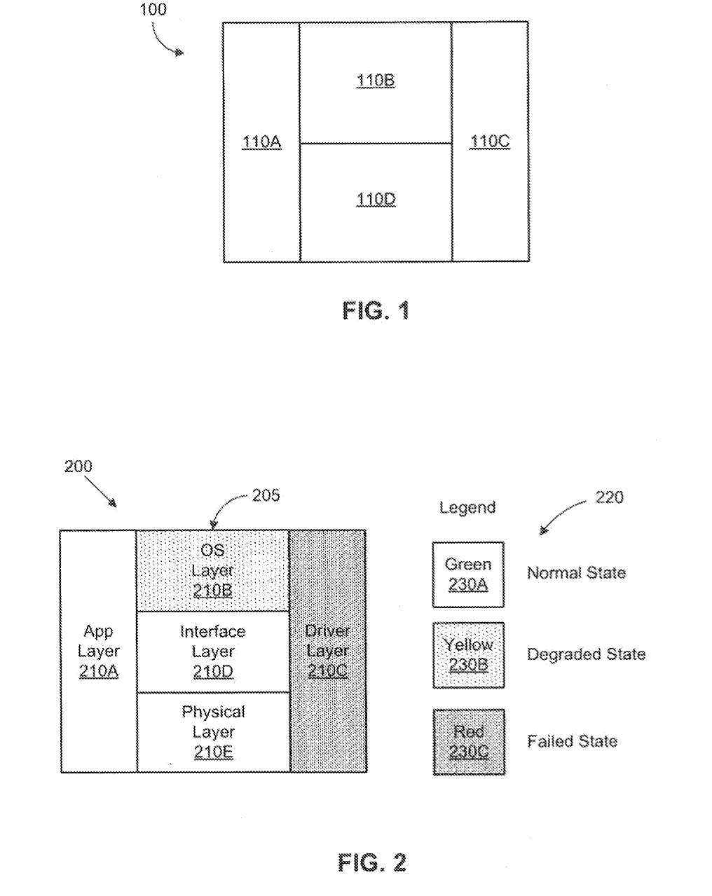

FIG. 1 shows a dynamic icon 100 divided into a plurality of different subparts or subzones 110A, 110B, 110C, and 110D in accordance with an example embodiment. Each sub-zone or sub-part is updated with changes in color, text, symbolism, and/or other indicia to display a holistic or local state of a monitored system or a specific device. For example, each zone 110A-110D represents or indicates a status of different and/or unique hardware and/or software components for an electronic device in a storage system.

FIG. 2 shows an icon system 200 in accordance with an example embodiment. The system includes a dynamic icon 205 and a legend 220. The icon 205 has a plurality of different zones or parts, labeled 210A, 210B, 210C, 210D, and 210E. By way of example, each zone or part corresponds to a state or operating condition for an electronic device, such as a server or other device in a storage system. Each zone or part displays different or independent information to the user about the electronic device. This information is displayed in conjunction with legend 220.

As shown in FIG. 2, the icon 205 can display different visual characteristics to indicate to an operating condition to a user. These characteristics include color, patterns, text, images, etc. For example, a different color is associated with a different operating characteristic. As shown in legend 220, the color green represented that a state or component of the electronic device is operating in a normal state 230A; yellow represents that a state or component is in a degraded state 230B; and red indicates that a state or component is in a failed state 230C.

FIG. 2 shows five different characteristics or components being evaluated for the electronic device. The names of these components can be displayed to the user in a respective zone or part to remind the user what the zone represents. For instance, these zones or parts and their respective components being monitored include: an application layer 210A, an operating system (OS) layer 210B, a driver layer 210C, an interface layer 210D, and a physical layer 210E. The color of each zone or part indicates how the component is operating. As shown, the application layer (subpart 210A), the interface layer (subpart 210D), and the physical layer (subpart 210E) are all operating normally. The operating system layer (subpart 210B) is operating in a degraded state, and the driver layer (subpart 210C) is operating in a failed state.

Upon seeing the icon 205, a user or system administrator can quickly discern the operational health of the electronic device. A single icon simultaneously presents multiple different states for different components of an electronic device, devices, or a subsystem.

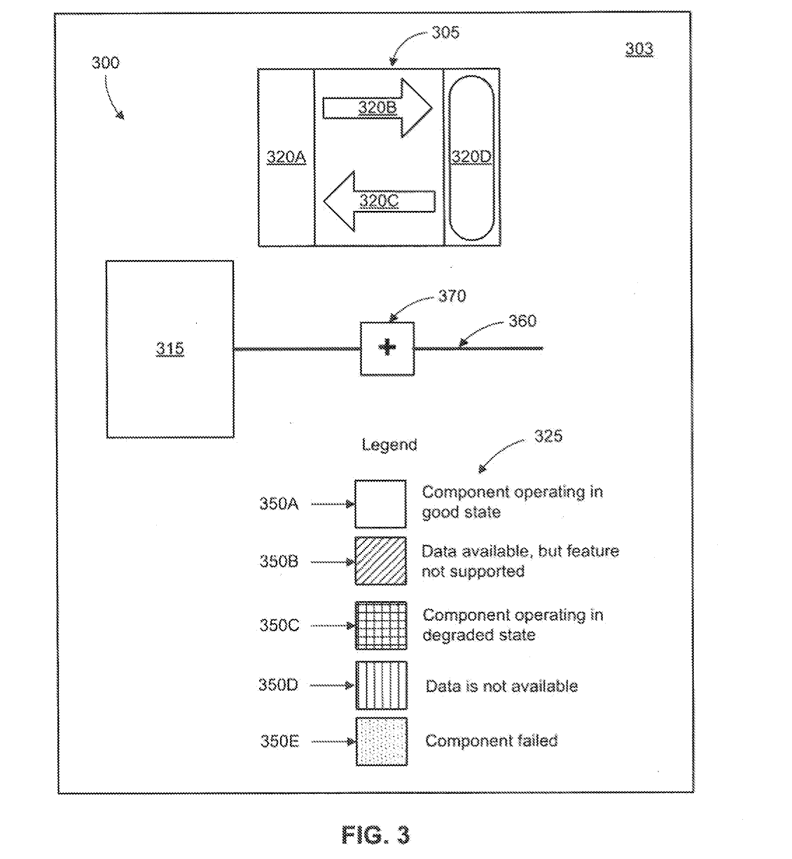

In one embodiment, the icons are displayed next to or adjacent to their corresponding device on a computer or display. FIG. 3 shows an icon system 300 provided on a display 303 (e.g., a display of a management server or computer that monitors a data center). The system 300 includes a dynamic icon 305, an image of an electronic device (shown as box 315), and a legend 325. The icon is physically located next to the electronic device to indicate that it is providing information for the device.

Icon 305 includes four different zones or parts 320A, 320B, 320C, and 320D. In addition to color, these zones or parts can include a picture or graphical image of an object to assist in visually displaying information to the user. For example, zones 320B and 320C include arrows, and zone 320D includes an oval.

Legend 325 provides example operating conditions or states that can be displayed in the icon for the respective device. By way of example, these conditions include, but are not limited to, 350A (shown as being white to indicate the component operating in a good condition), 350B (shown with a color and/or slanted lines to indicate data is available, but the condition or feature of the component is not supported), 350C (shown with a color and/or grid lines to indicate the component is operating in a degraded state), 350D (shown with a color and/or vertical lines to indicate data is not available), and 350E (shown with a color and/or dots to indicate the component has failed).

Each zone or part in the icon is dedicated to displaying the status of particular hardware and/or software component of the corresponding device. The following examples are provided for an electronic device 315 (such as a host bus adapter, HBA, a switch, or a storage device) that is located in a data center. For example, zone 320A indicates if the device driver returns SFP/RFID data. Zone 320B includes an arrow that points away from device 315. This direction of the arrow indicates that the arrow reflects the transmitter status, and color is used to define the transmitter state. Zone or part 320C includes an arrow that points toward the device 315. This direction of the arrow indicates that the arrow reflects the receiver status, and color is used to define the receiver state. Zone or part 320D includes an oval or ellipse which represents RFID in a cable. Standard SFP will display that no data is available.

A cable 360 extends from device 315. The cable can be colored on the display to indicate a state of the cable (e.g., green indicates the cable is in a normal state; yellow indicates the cable is in a degraded state; and red indicates the cable is in a failed state). Furthermore, the color of the cable or line can be dependent on data flow in each fibre in the data center.

The cable 360 is also provided with a clickable or expandable box 370. Clicking on the plus sign in the box will provide further information, such as showing SFP/RFID information for the device 315.

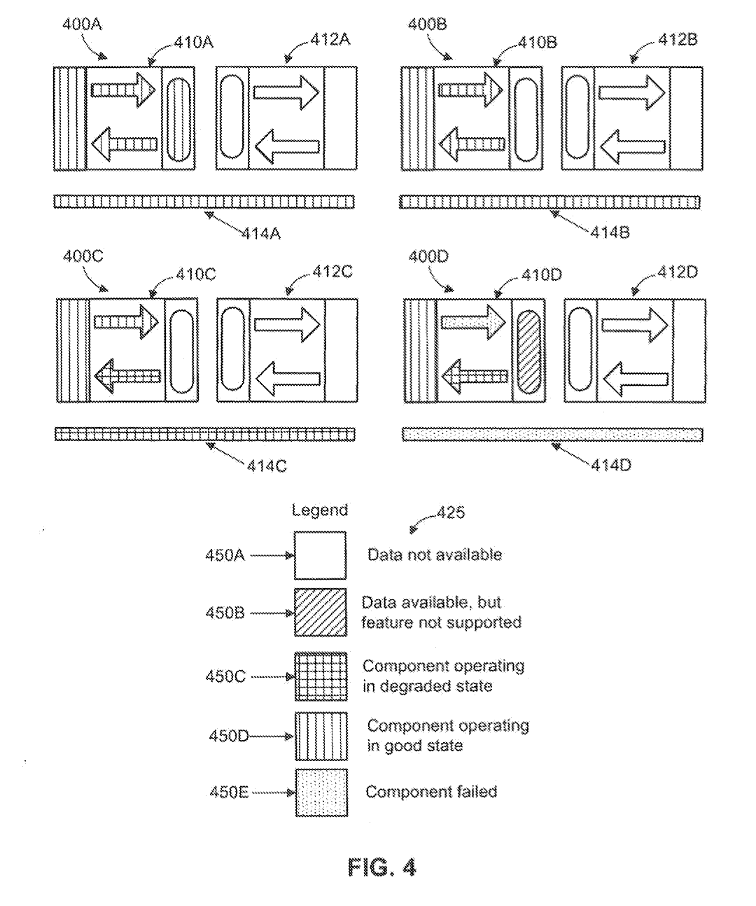

In one embodiment, plural dynamic icons are assembled or used together to provide an operational state or condition of a larger system. FIG. 4 provides examples of four different sets of icons 400A, 400B, 400C, and 400D that are displayed in conjunction with legend 425 to provide information about a one-sided cable subsystem in a data center. Each set of icons includes three icons (shown as respective 410A-410D, 412A-412D, and 414A-414D) colored or patterned according to the legend to indicate a different operation state for the corresponding system represented by the icons.

Legend 425 provides example operating conditions or states that can be displayed in the icon sets for the respective systems. By way of example, these conditions include, but are not limited to, 450A (indicating data is not available for the component), 450B (indicating data is available, but the condition or feature of the component is not supported), 450C (indicating the component is operating in a degraded state), 450D (indicating the component is operating in a good state), and 450E (indicating the component failed).

Icon set 400A indicates data is available. A laser and PIN diode are operating within typical or good levels. Cable has RFID tag and data is being read from the cable.

Icon set 400B indicates SFP is operating in a good state. The cable does not have RFID tag or SFP is standard and not enhanced.

Icon set 400C indicates SFP is operating in a degraded state. The cable does not have RFID or SFP is standard and not enhanced. A PIN diode signal is below margin levels.

Icon set 400D indicates SFP is operating in a degraded state. The cable does not have RFID or SFP is standard and not enhanced. A PIN diode signal is below margin levels.

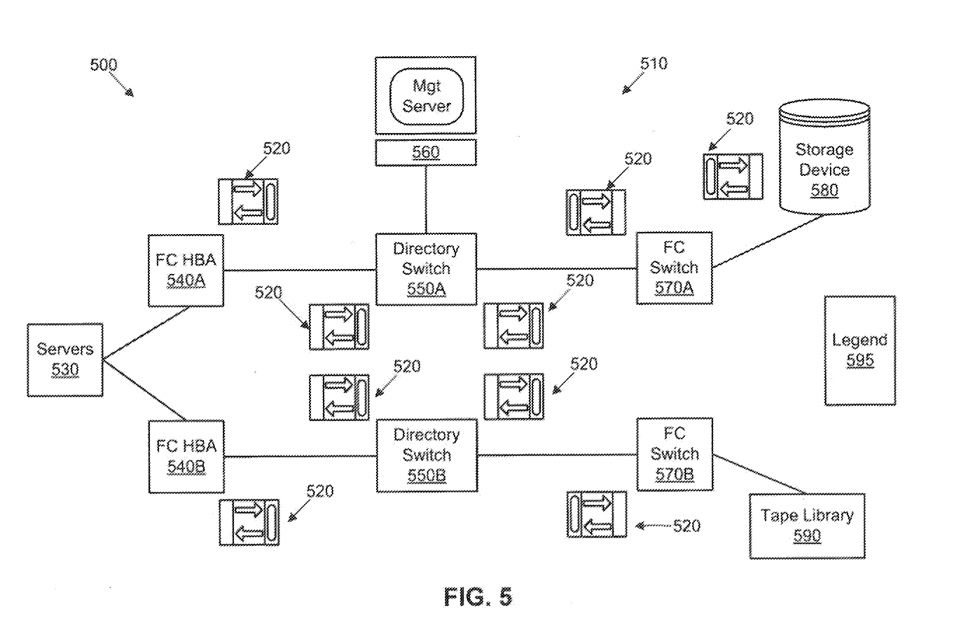

FIG. 5 shows a topology map 500 of data center 510 using dynamic icons 520 to display local and systemic information in accordance with an example embodiment. The topology map 500 is displayed or presented on a computer to a user or service administrator.

The map 500 illustrates a few example electronic devices in a data center and includes one or more computers or servers 530 (including one or more hosts or clients), fibre channel host bus adapters (FC HBA) 540A and 540B, directory switches 550A and 550B, a management station or server 560, fibre channel switches 570A and 570B, a storage device 580, and a tape library 590 coupled together with one or more networks (shown with solid lines). A legend 595 is also provided. The legend 595 and icons 520 can have various configurations, such as those discussed in connection with FIGS. 1-4.

Although FIG. 5 shows a data center, example embodiments can be applied to any complex system, such as storage systems, fibre optical systems, etc. For example, the system includes a monitoring algorithm that determines when an optical subsystem is good, degraded, or failed. The last two states (degraded and failed) cause a diagnostic algorithm to launch.

Constructing a dynamic icon can be done in many ways. One method is to implement each dynamic icon as a collection of threads. Each zone part would represent its own thread. Furthermore, the dynamic icons can be used in display systems to provide a large amount of disparate information in an efficient manner. The icons support multiple entities, such as hardware, software, and abstract representation. Multiple icons can be controlled together to present systemic information.

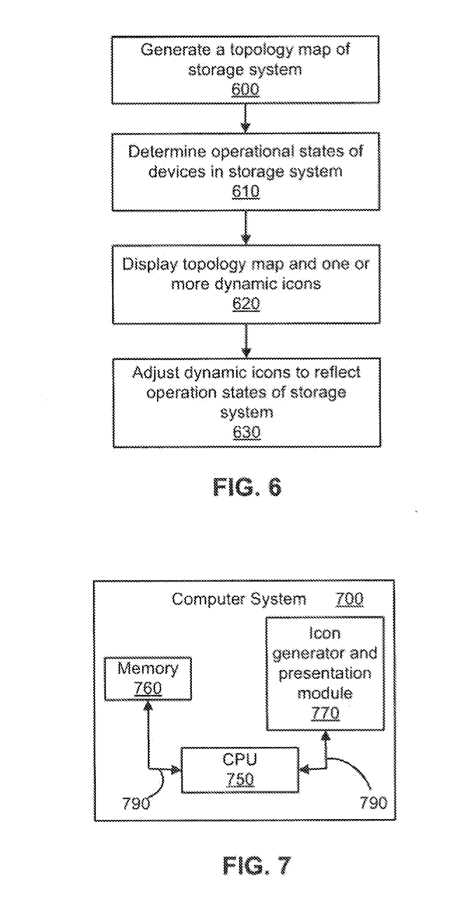

FIG. 6 shows a flow diagram for generating and displaying dynamic icons to provide state information about a storage system in accordance with an example embodiment.

According to block 600, a topology map of a storage system is generated. The topology map includes one or more dynamic icons.

According to block 610, one or more operational states of the storage system are evaluated and determined. For example, the operational states or condition of various electronic devices in the storage system are evaluated.

According to block 620, the topology map and icons are displayed. For example, the topology map of a data center is presented or provided to a system administrator on a computer (such as management computer 560 in FIG. 5). The topology map includes one or more dynamic icons.

According to block 630, the dynamic icons are adjusted to reflect the operational states of the storage system. For example, the icons are changed in real-time (such as changing one or more of color, text, information presented in a zone or part, etc.).

FIG. 7 illustrates an example computer system 700 in accordance with example embodiments. By way of example, the computer system is a management server or computer for managing a storage system (such as management computer 560 in FIG. 5). The computer system 700 includes a processing unit 750 (such as one or more processors of central processing units, CPUs) for controlling the overall operation of memory 760 (such as random access memory (RAM) for temporary data storage and read only memory (ROM) for permanent data storage) and an icon generator and presentation algorithm or module 770 for implementing example embodiments discussed herein. The memory 760 stores data, control programs, and other data associate with the computer system 700. In some embodiments, the memory 760 stores the module 770. The processing unit 750 communicates with memory 760, data base 730, cable monitoring and module 770, and many other components via buses 790.

### DEFINITIONS

As used herein and in the claims, the following words are defined as follows:

The term “complex time varying system” is any system that is comprised of n subsystems, where each subsystem's functions are automated over some time period and each subsystem's operational parameters are correlated. Typically the number of subsystems n>>2.

The term “data center” is a facility that houses multiple servers, computer systems, and associated components. Data centers generally include racks of servers, multiple routers and switches, storage devices, and other components interconnected through cables.

The term “storage device” means any data storage device capable of storing data including, but not limited to, one or more of a disk array, a disk drive, a tape drive, optical drive, a SCSI device, or a fiber channel device. Further, a “disk array” or “array” is a storage system that includes plural disk drives, a cache, and controller. Arrays include, but are not limited to, networked attached storage (NAS) arrays, modular SAN arrays, monolithic SAN arrays, utility SAN arrays, and storage virtualization.

The term “storage system” is a computer system that provides storage for one or more hosts or clients.

In one example embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with example embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit the invention.

In the various embodiments in accordance with the present invention, embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible computer-readable media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
generating a topology map with icons that represent devices in a storage system; and
displaying one of the icons with a plurality of subparts with each of the subparts presenting different state information about one of the devices in the storage system.

2) The method of claim 1 further comprising, adjusting in real-time information being displayed in the subparts when the state information about the one of the devices changes.

3) The method of claim 1 further comprising, changing a color of one of the subparts when the state information about the one of the devices changes.

4) The method of claim 1, wherein each of the plurality of subparts indicates a status of a different hardware or software component of the one of the devices.

5) The method of claim 1 further comprising, generating the one of the icons to have four different subparts.

6) The method of claim 1, wherein each of the plurality of subparts includes both color and text that indicate state information about the one of the devices.

7) A tangible computer readable storage medium having instructions for causing a computer to execute a method, comprising:
generating a map of a storage system; and
generating a dynamic icon in the map, the dynamic icon divided into multiple zones that simultaneously depict different operational information about a single electronic device in the storage system.

8) The tangible computer readable storage medium of claim 7 further comprising, generating a legend that shows different operational states using different colors for the zones of the dynamic icon.

9) The tangible computer readable storage medium of claim 7, wherein each of the zones is dedicated to displaying a unique operational state of the electronic device.

10) The tangible computer readable storage medium of claim 7, wherein the operational information includes a normal state, a degraded state, and a failed state for the electronic device.

11) A storage system, comprising:
a server;
a storage device in communication with the server; and
a management computer that displays a map of the storage system, the map includes a dynamic icon divided into multiple parts that simultaneously depict different operational states of an electronic device in the storage system.

12) The storage system of claim 11, wherein the multiple parts visually depict information about an operating system layer of the electronic device, an application layer of the electronic device, an interface layer of the electronic device, and a driver layer of the electronic device.

13) The storage system of claim 11, wherein the multiple parts include graphical images that indicate information about one of the different operational states.

14) The storage system of claim 11, wherein the map further includes two dynamic icons displayed adjacent each other, the two dynamic icons indicating a plurality of different states for hardware and software for an electronic device in the storage system.

15) The storage system of claim 11, wherein each of the multiple parts is displayed with a different color to indicate different operation states for different components of the electronic device.
